(19) United States
(12) Patent Application Publication
(10) Pub. No.: US 2005/0154899 A1
(43) Pub. Date: Jul. 14, 2005

(54) Mobile software authentication and validation

(75) Inventors: Lisa Marie Marvel, Churchville, MD (US); Lori Lee Pollock, Landenberg, PA (US); Michael James Jochen, Newark, DE (US)

Correspondence Address: U S ARMY RESEARCH LABORATORY;ATTN AMSRL CS CC IP, 2800 POWDER MILL RD, ADELPHI, MD, 207831197, US

(73) Assignee: The United States of America as represented by the Secretary of the Army, Adelphi, MD (US)

(21) Appl. No.: 11/030,671

(22) Filed: Jan. 6, 2005

Related U.S. Application Data
(60) Provisional application No. 60/535,574, filed on Jan. 9, 2004.

(51) Int. Cl. H04L 9/32

(52) U.S. Cl. 713/187

(57) ABSTRACT

Methods for encoding and validating a computer program are disclosed. A program is encoded by transforming the program using a canonical transform based at least in part on a partitioning algorithm, creating an encrypted hash value based at least on the transformed program and an encryption key, and embedding the encrypted hash value in the transformed program. A program embedded with the encrypted hash value is validated by receiving the program embedded with the encrypted hash value, transforming the program embedded with the encrypted hash value using a canonical transform based at least in part on a partitioning algorithm; comparing the received program and the transformed program to extract a first encrypted hash value, creating a second encrypted hash value-based at least on the transformed program and an encryption key, and validating the program responsive to the first and second encrypted hash values.

### FIELD OF THE INVENTION

The present invention relates to the field of computer software and, more particularly, to methods for authenticating and validating software transferred from one computer to another.

### BACKGROUND OF THE INVENTION

A significant portion of computer software (herein software) is delivered over networks from remote hosts (servers) to local hosts (clients) just prior to execution. This type of software is often referred to as mobile software. The integrity of mobile software is an important aspect for its secure execution. Authentication of the originating server is another. For instance, mobile software downloaded from a remote host to a local host could arrive from a charlatan host or be tampered with by an unauthorized party during transit. Once in execution on the local host, the tampered software could damage local or distributed resources and possibly compromise information integrity. The risk also exists for a malicious host to cause harm to mobile software such as altering or forging software that passes through the malicious host. Thus, any system can potentially expose itself to a great many vulnerabilities by utilizing mobile software.

Current state-of-the-art techniques to detect/deter tampering or to attest to claims of identity (authentication) of mobile software include the use of hash digests, digital signatures, and digital certificates. All three methods require that extraneous information be communicated to the receiving entity, thereby utilizing additional bandwidth. With digital certificates, additional communication with a third party certificate server is also involved. There are also dynamic (non-static) tamper detection techniques in which execution of the code is required prior to detection. Thus, tampered mobile software is initially allowed to execute on the local host, which may result in damage to the local host.

As services develop and lightweight devices become more prevalent, the use of mobile software is expected to continue and expand. Accordingly, methods for authenticating and validating mobile software, which are not subject to the above limitations, are needed. The present invention fulfills this need among others.

### SUMMARY OF THE INVENTION

The present invention includes methods for encoding and validating a computer program. A computer program is encoded by transforming the computer program using a canonical transform based at least in part on a partitioning algorithm, creating an encrypted hash value based at least on the transformed computer program and an encryption key, and embedding the encrypted hash value in the transformed computer program. A computer program embedded with the encrypted hash value is validated by receiving the computer program embedded with the encrypted hash value, transforming the computer program embedded with the encrypted hash value using a canonical transform based at least in part on a partitioning algorithm; extract a first encrypted hash value based on the received computer program and the transformed computer program, creating a second encrypted hash value based at least on the transformed computer program and an encryption key, and validating the computer program responsive to the first and second encrypted hash values.

### BRIEF DESCRIPTION OF THE DRAWINGS

The invention is best understood from the following detailed description when read in connection with the accompanying drawings, with like elements having the same reference numerals. Included in the drawings is the following figure:

FIG. 1 is a block diagram of a computer software validation and authentication system in accordance with the present invention.

### DETAILED DESCRIPTION OF THE INVENTION

The invention will also be better understood with reference to the attached Appendix A entitled “A Framework for Tamper Detection Marking of Mobile Applications.” In the context of this disclosure, the terms mobile code, software, computer program, and application are used interchangeably. Whereas the term mobile code typically is defined to be code that physically relocates during the lifetime of its execution, a very loose definition is employed in that any code not compiled on the machine that is running the code is said to be mobile. Thus, almost all code can be defined as mobile code, and as the present invention is designed to detect tampering within mobile code, it can be applied to almost any code.

To address these matters, the present invention provides a framework that enables users of mobile code (herein a computer program) to validate the computer program with an integrity and authentication process while simplifying the distribution of data for these processes. The integrity process ensures that the computer program has not been tampered with since it left the remote host and the authentication process ensures that the remote host is a known host. In an exemplary embodiment, tamper and authentication data, called a Tamper Detection Mark (TDM), is embedded within the computer program as a way to address the issues of code integrity and authentication. It can be utilized to detect virtually any degree of tampering or alteration to a computer program and, in a preferred embodiment, is communicated via hybrid steganographic-cryptographic techniques that embed the TDM within the computer program. In an exemplary embodiment, the use of hybrid steganographic-cryptographic techniques obscures the existence of the TDM from casual view without increasing the size of the program (and, thus, its bandwidth requirements).

In an exemplary embodiment, the computer program may run without validating the integrity and authentication of the computer program. In this embodiment, a computer program carrying a TDM is semantically equivalent to the original computer program and can execute without any special pre-processing. This is particularly useful should authentication of the computer program not be desired or should the computer program execute on a system that does not have an implementation of the framework. Initial experimental results show no runtime performance degradation for the execution of the protected program.

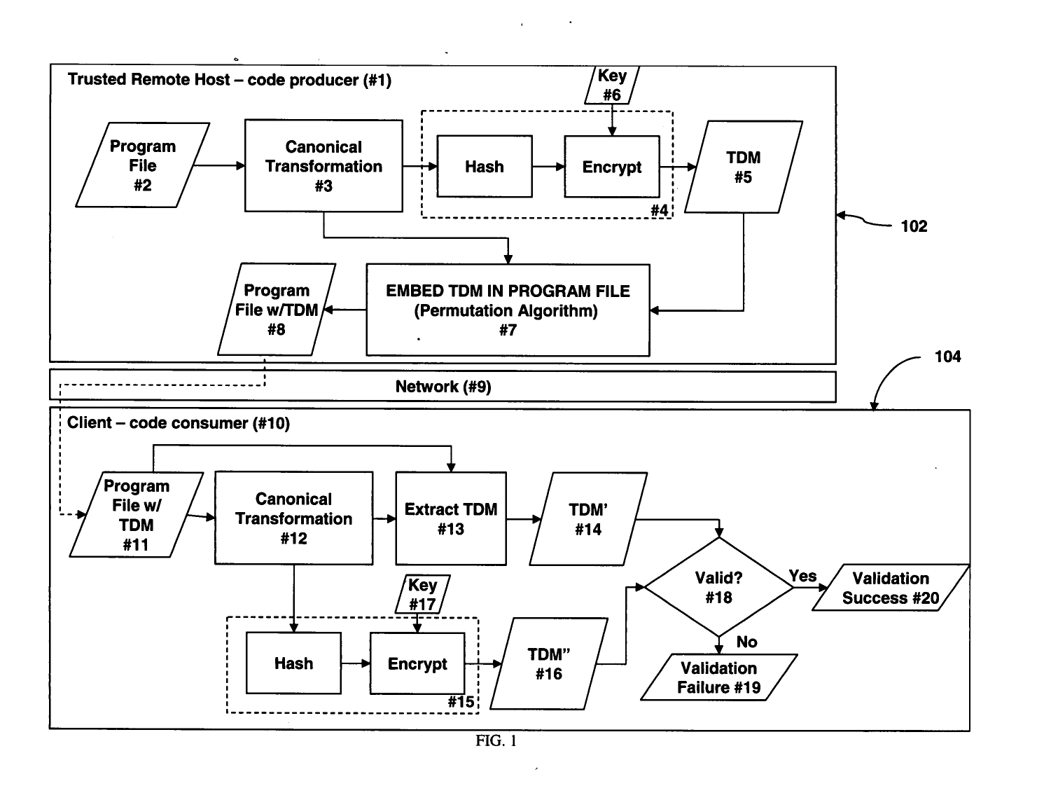

FIG. 1 depicts an exemplary tamper detection system 100 in accordance with the present invention. The tamper detection system 100 includes a embed phase 102 and a validate phase 104. The embed phase 102 typically takes place on a remote host computer/server which compiles the source code and produces the computer program while the validate phase 104 occurs on the local host computer/client that desires to execute the computer program.

A exemplary embodiment utilizing the tamper detection system 100 is now described. A remote host computer/server/code producer (#1) compiles a computer program (#2), transforms the computer program based at least in part on a determined partitioning algorithm into canonical form (#3), computes (#4) a TDM (#5) using a hash of the transformed computer program and an encryption key (#6), embeds (#7) the TDM within the computer program (#8), and makes the program available for download over the network (#9). The local host computer/client/code consumer (#10) downloads the computer program embedded with the TDM (#11) and transforms the computer program based at least in part on a determined partitioning algorithm into canonical form (#12). The local host computer (#10) then authenticates and validates the computer program by comparing the received computer program to the transformed computer program to extract (#13) the embedded TDM (i.e., TDM′) (#14) and, independently, computing (#15) a TDM (i.e., TDM″) (#16) using a hash of the transformed computer program and an encryption key (#17). The two TDMs (TDM′ and TDM″) are then compared (#18). If they match, the validation succeeds (#20) and the local host computer is assured that the computer program was received unaltered from the remote host computer and proceeds with execution of the computer program. Otherwise, the computer program cannot be validated and a validation failure (#19) is generated.

In an exemplary embodiment, the TDM is created by transforming the computer program to canonical form, computing a hash value of the computer program in canonical form and combining the hash value with an encryption key in some manner (e.g., hash-based message authentication code “HMAC,” encrypting the hash value with a secret key, etc). Since the computer program is validated with a hash digest of the computer program, the local host and the remote host are synchronized by starting with a computer program of identical form via the canonical transformation. Embedding a TDM in the program typically results in a program of a different form, as does compiling the same program by different compilers; hence there is the requirement of transforming the program to a “canonical form” before the hash value is computed.

The canonical form of a computer program is achieved by sorting various sections of the computer program based on some criteria derived from the format of executable program files for the given architecture. After the computer program is sorted, many areas of the computer program are updated to reflect the new form of the computer program. The reordering and updating schemes ensure that a computer program in canonical form is a valid program that can execute on a regular machine with no special preprocessing. With the computer program in canonical form, the hash value of the computer program can be computed. The computer program is hashed and combined with a secret key to form the TDM. This key is currently shared between the remote host and the local host (i.e., a symmetric key system) although the present invention could be extended to use a public key system. In the illustrated embodiment, the TDM serves as a cryptographic checksum for the computer program. In an alternative exemplary embodiment, the hashed value that is encrypted separately serves as a cryptographic checksum for the computer program. Appropriate modifications to the validate phase 104 in accordance with this embodiment will be understood by those of skill in the art.

In an exemplary embodiment, the TDM is embedded in a computer program by permuting the order of selected sections within the computer program in canonical form using a known permutation algorithm. To reorder a given section of size n within a computer program to encode a TDM, the n^{th} permutation of all possible orderings of that section is selected. Manipulating the contents of a computer program typically requires that the entire computer program is updated to reflect the new form of the computer program. The embedded TDM is now part of the computer program. It is noted that the TDM requires no additional space within the computer program since the TDM is encoded within the computer program as the order of the selected sections and, thus, the computer program's size remains constant.

Once the TDM is embedded within the computer program, the computer program is ready for transmission to the local host. The new computer program created during the embed phase 102 is semantically equivalent to the original computer program and, thus, the same computation is performed and the runtime performance of the computation should not be affected. This new computer program with embedded TDM is able to execute on any machine with no special pre-processing.

Once the computer program has arrived at the local host from the remote host, the validate phase 104 begins and the local host can validate the code in accordance with the present invention. During the validate phase 104, the TDM of the computer program is extracted for use in validating the computer program. The first steps of validating a TDM are similar to embedding a TDM. The computer program is transformed to canonical form, and an encrypted hash of the computer program is computed. The TDM is then extracted from the computer program by reversing the permutation algorithm. To extract the TDM, the sequence of the predetermined sections (in canonical form) is compared to the permuted sequence (e.g., using a look-up table) to determine which of the possible permutations is encoded in this order. The extracted TDM is compared with the locally computed TDM. If the code has not been altered since insertion of the TDM and the proper keys have been used to create and validate the TDM, the validation result will return true. Any alteration to the computer program or incorrect key usage will result in failure during the validation phase, thereby indicating that the source is not authenticated or the computer program is invalid/corrupt.

In an exemplary embodiment, the following parameters are determined:
1. Regions of the computer program that can accommodate a TDM.
2. A unit of granularity for hiding information within the above regions (i.e., permutable blocks).
3. Carrying capacity or stego-bandwidth available within the above regions, which is a function of the size of the region(s) available within the computer program.
4. A partitioning scheme for creating the individual premutable units based on the granularity within the regions to hold the TDM.
5. A canonical form of the file:
   Properties necessary to achieve canonical form and maintain semantic equivalence with the original program.
   How to automatically transform the original computer program to canonical form.
6. How to create the TDM.
7. How to embed the TCM within the computer program.

In considering the first issue, the embedding region, the details of the target architecture of the computer program must be thoroughly understood, as well as the format of the computer program for the given architecture. Some areas within a computer program may not be open to manipulation, while others will accommodate a great deal of modification without changing the semantics. Within the region that stores or encodes the TDM (i.e., mark), the size or granularity of the individual units dictate the amount of bandwidth available to encode the mark. The order of these individual units will be permuted to encode the mark. Supplemental hiding places can be employed such as unused instruction bits and empty padding areas if there are not enough useable areas to embed the mark.

To identify permutable units, the region encoding the TDM may need to be explicitly partitioned. The partitioning step depends on the nature of the permutable unit within the computer program. Once the region to encode the TDM has been identified, and the permutable units created, the nature of the computer program's canonical form is defined. The canonical form of a computer program typically involves sorting the permutable units within the region encoding the TDM and then updating the program file to reflect the new form. Once the canonical form is achieved, the TDM is created and embedded within the computer program.

In an exemplary embodiment, the TDM is embedded into this canonical form with particular attention to ensuring:
The semantics of the computer program remain constant (i.e., the computer program performs the same computation).
The local host is able to transform the computer program to the canonical form independent of the remote host.
The hiding capacity of the region can accommodate the size of the TDM.
The size of the computer program with TDM is no larger than the original computer program.
Extracting and validating the TDM will reveal tampering with the computer program.
The time and space to perform the transformations to canonical form, embedding and validation of the TDM are acceptable to mobile code users.

The amount of bandwidth for the TDM is determined by the size of the region encoding the mark and the number of permutable units within that region. A region with n permutable units has n! unique orderings and, thus, can encode a value strictly less than n!. For example, when SHA-1 is used for the hash digest and the hash value is encrypted via 3DES (in ECB mode), a 192 bit TDM (160-bit hash value padded to 192 bits for three 64-bit blocks) is established. A 192-bit TDM requires a class file with at least 47 entries (2192=47!). Similarly, a TDM consisting of an MD5 hash digest encrypted via DES requires 35 permutable units in the region.

The present invention provides an end-user optional, energy-efficient, decentralized authentication and validation technique that is performed in a static manner. A TDM is embedded in a computer program in such a way as to preserve the computer program's semantics and in doing so makes the process of tamper detection and authentication optional. It is also energy efficient in power, bandwidth, and communication. The algorithms used are not computationally intensive and, therefore, conserve power. The TDM does not increase the computer program file size so no additional bandwidth is required and since the technique is distributed, there is no need to rely on a third party that would necessitate added communication. Additionally, this decentralized system eliminates the vulnerability caused by the employment of a third party certificate server which could function as a single point of failure in a system. Lastly, tamper detection and authentication are performed in a static manner; without executing the code that could possibly be malicious.

Although the invention is illustrated and described herein with reference to specific embodiments, the invention is not intended to be limited to the details shown. Rather, various modifications may be made in the details within the scope and range of equivalents of the claims and without departing from the invention. For example, the present invention may be applied to essentially any type of programming language. Also, in addition to tamper detection and authentication, the present invention may be used to hide information within software for essentially any purpose.

1. A method for encoding a computer program, the method comprising the steps of:
transforming the computer program using a canonical transform based at least in part on a partitioning algorithm;
creating an encrypted hash value based at least on the transformed computer program and an encryption key; and
embedding the encrypted hash value in the transformed computer program.

2. A method for validating a computer program embedded with an encrypted hash value, method comprising the steps of:
receiving the computer program embedded with the encrypted hash value;
transforming the computer program embedded with the encrypted hash value using a canonical transform based at least in part on a partitioning algorithm;
extracting a first encrypted hash value based on the received computer program and the transformed computer program;
creating a second encrypted hash value based at least on the transformed computer program arid an encryption key; and
validating the computer program responsive to the first and second encrypted hash values.

3. A method for encoding a computer program, the method comprising the steps of:
determining regions of the computer program that can accommodate an encoded hash value;
determining a unit of granularity for inserting information within the determined regions;
developing a partitioning scheme, the partitioning scheme for partitioning the computer program to hold the encoded hash value based on the determined granularity within the determined regions;
transforming the computer program using a canonical transformation based on the developed portioning scheme.
creating an encoded hash value based on the transformed computer program; and
embedding the encoded hash file within the transformed computer program.
